(19) United States
(12) Patent Application Publication
(10) Pub. No.: US 2014/0239819 A1
(43) Pub. Date: Aug. 28, 2014

(54) Centralized Photosensitive LED Streetlight Control System

(71) Applicants: SHANGHAI SANSI ELECTRONICS ENGINEERING CO., LTD, Shanghai (CN); SHANGHAI SANSI TECHNOLOGY CO., LTD., Shanghai (CN); JIASHAN SANSI PHOTOELECTRICITY TECHNOLOGY CO., LTD., Jiaxing (CN)

(72) Inventors: Yinghua Wang, Shanghai (CN); Ming Chen, Shanghai (CN); Yanyan Sun, Shanghai (CN); Na Feng, Shanghai (CN)

(73) Assignees: Shanghai Sansi Electronics Engineering Co., Ltd, Shanghai (CN); Jiashan Sansi Photoelectricity Technology Co., Ltd., Jiaxing (CN); Shanghai Sansi Technology Co., Ltd., Shanghai (CN)

(21) Appl. No.: 13/776,716

(22) Filed: Feb. 26, 2013

(51) Int. Cl. H05B 37/02

(52) U.S. Cl. CPC H05B 37/02
USPC 315/154

(57) ABSTRACT

A centralized photosensitive LED streetlight control system, includes a control center, a number of LED streetlights and multiple field distribution boxes, with each field distribution box supplying power to multiple LED streetlights in a centralized way, and also includes multiple field controllers used in a complementing way with field distribution boxes. The field controller consists of photosensitive sensor, processor, power switch control unit and communication module, with the power switch control unit connecting to the power switch of field distribution box, the processor collecting and converting photosensitive sensor signal and outputting after analyzing and judging the control signal to the power switch control unit to control the power switch of field distribution box; the communication module connecting with the control center network for the control center to monitor in real time the working states of field controller and power switch.

### TECHNICAL FIELD

This invention relates to LED lighting field, more specifically to a centralized photosensitive LED streetlight control system.

### BACKGROUND OF INVENTION

Streetlights using LED as a light source have been used widely on many roads. To save energy, it is required that streetlights can become on and off automatically according to the brightness of outer environment. The conventional method for this is decentralized control method, that is, installing a photosensitive sensor on each LED streetlight which controls the power switch for LED streetlight according to the strong and weak light signals sensed by it and thus controls the on and off of the same. However, as LED streetlights are great in number, the above decentralized independent control method developed for each LED streetlight increases the complexity of the control system undoubtedly, moreover, to install a photosensitive sensor for each of a huge number of LED streetlights undoubtedly increases the manufacture cost of system substantially. At the same time, when the photosensitive sensors become abnormal, such phenomenon as some lights being on, some being off and lights being on during daytime and off in the evening may occur and the road management department is unable to master such abnormal cases and repair timely.

### INVENTION SUMMARY

To resolve the above technical problem within the existing technology, the invention provides a centralized photosensitive LED streetlight control system to realize a relatively centralized control over a huge number of LED streetlights, reduce the complexity of control system and the manufacture cost of system.

To achieve the above purpose, the invention adopts the following technical solution.

A centralized photosensitive LED streetlight control system, including a control center, a number of LED streetlights and multiple field distribution boxes, with each of the field distribution boxes supplying power in a centralized way for multiple LED streetlights, also including multiple field controllers used in a complementing way with the field distribution boxes, with the field controller consisting of photosensitive sensor, processor, power switch control unit and communication module, the power switch control unit connecting to the power switch of field distribution box, the processor collecting and converting photosensitive sensor signal and outputting after analyzing and judging the control signal to the power switch control unit to control the power switch of field distribution box and thus control the centralized on and off of multiple LED streetlights supplied by the field distribution box; the communication module connecting with the control center network for the control center to monitor in real time the working states of field controller and power switch.

The control center makes a communication connection with each field controller through wire or wirelessly.

The field controller is installed on the field distribution box.

There can be one photosensitive sensor, one set of combined many photosensitive sensors or many photosensitive sensors used for standby may be included on each of the field controllers.

The field controller realizes the simultaneous control function of both clock and photosensitive sensor through software.

The field controller realizes the memory control function through software, namely, when all photosensitive sensors fail, it can effect control according to the on and off times of streetlight on the last day.

In the technical solution adopted in this invention, a field controller used in a complementing manner with field distribution box is added, which controls the switch power of field distribution box according to the photosensitive sensor signal to integrate the previous mode of independent photosensitive decentralized control of each streetlight into relatively centralized control in an area resulting in the need for photosensitive sensors being greatly reduced and the on and off of streetlights being unified. At the same time, in relation to single streetlight control mode, the control points in this invention are greatly reduced (which are equal in number to field distribution boxes used). As a result, the complexity of control system is lower, so is the manufacture cost. Also, it makes the streetlight control center be able to master the failure and operating conditions of photosensitive sensors and power switches.

### DESCRIPTION OF FIGURES

FIG. 1 is the composition block diagram of the control system of this invention.

FIG. 2 is the composition block diagram of the field controller in FIG. 1.

### EMBODIMENT

The centralized photosensitive LED streetlight control system provided by this invention is described below through figures and embodiment example.

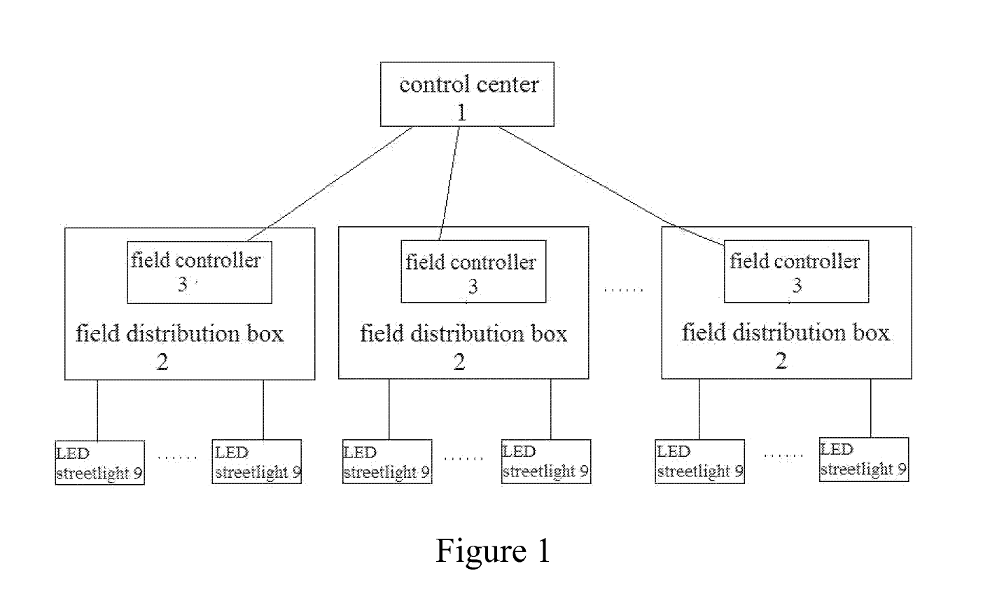

FIG. 1 is the composition block diagram of the control system of this invention, including control center 1, multiple field distribution boxes 2 and field controllers 3 used in a complementing way with field distribution boxes 2 on one-to-one basis. In this embodiment example, field controller 3 is installed in field distribution box 2 and can also be a control box separately set up. Field controller 3 connects with the power switch of field distribution box 2. One field distribution box 2 can provide a working power supply for multiple LED streetlights 9. Therefore, one field controller 3 can control the on and off of the multiple LED streetlights 9.

If one field distribution box 2 is to control multiple LED streetlights of two ways or more, it can be realized by configuring corresponding two or more power switches, each of which is put under control of field controller.

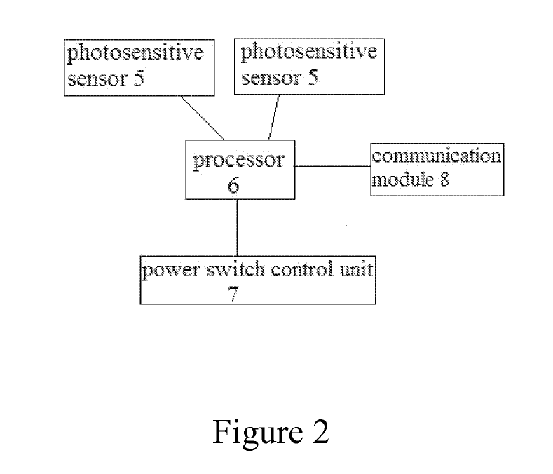

As shown in FIG. 2, field controller 3 consists of photosensitive sensor 5, processor 6, power switch control unit 7 and communication module 8. Photosensitive sensor 5 is installed on the outer side of field distribution box 2. To avoid the problem of streetlight out-of-control resulting from failure of one photosensitive sensor 5 or one set of photosensitive sensors 5, multiple photosensitive sensors or multiple sets of photosensitive sensors can be installed on each field controller 3 for standby; to avoid the problem of great differences in parameters for one set of photosensitive sensors, multiple sets of photosensitive sensors can also be installed simultaneously with the parameters of all photosensitive sensor to be averaged as the environmental brightness input parameter for field controller, which is a more accurate way. Power switch control unit 7 connects to the power switch of field distribution box 2. Processor 6 collects signals from photosensitive sensor 5 and makes A/D conversion, and analyzes and judges converted data, outputs a control signal to power switch control unit 7 which turns on or off the power switch on field distribution box 2 to control the on and off of multiple LED streetlights 9 governed by the field distribution box 2. The communication module 8 of field controller 3 connects with control center 1 through wire or wirelessly to realize information feedback and real-time monitor between control center 1 and field controller 3. The working state of any power switch of photosensitive sensor 5 or field distribution box 2 will be fed back to control center 1, which can also issue a command to field controller 3 when necessary.

Through software programming, the processor 5 in field controller 3 can also be added with a clock to control the on and off function of streetlight, with a comprehensive consideration to be given with the on an off function of photosensitive sensor 5 to make light turning on time more rational. A memory function can also be realized through software, namely, when all photosensitive sensors 5 fail, a control can be effected over streetlights according to the on and off times on the last day and no normal use of streetlights is influenced.

The above embodiment is only used to describe the technical solution for this invention and can not be used to limit the protection range of this invention. Any variations and transformations made under the guide of the technical solution thought of this invention will be within the protection range of this invention.

What is claimed is:

1. A centralized photosensitive LED streetlight control system, comprising a control center, multiple LED streetlights and multiple field distribution boxes, wherein each of said field distribution boxes supplies power in a centralized way to said multiple LED streetlights, and also comprising multiple field controllers used in a complementing way with said field distribution boxes, wherein said field controller comprises photosensitive sensor, processor, power switch control unit and communication module, wherein said power switch control unit is connected to a power switch of said field distribution box; said processor collects and converts photosensitive sensor signal, outputs after analyzing and judges control signal to said power switch control unit to control the power switch of field distribution box, so as to control centralized on and off of said multiple LED streetlights supplied by said field distribution box; and said communication module is connected to a control center network for said control center to monitor in real time working states of said field controller and said power switch.

2. The centralized photosensitive LED streetlight control system according to claim 1, wherein said control center communicates with each field controller through wire or wirelessly.

3. The centralized photosensitive LED streetlight control system according to claim 1, wherein said field controller is installed in said field distribution box.

4. The centralized photosensitive LED streetlight control system according to claim 2, wherein said field controller is installed in said field distribution box.

5. The centralized photosensitive LED streetlight control system according to claim 1, wherein said photosensitive sensor on each of said field controllers can be one, one set of combined many or comprise many used for standby.

6. The centralized photosensitive LED streetlight control system according to claim 2, wherein said photosensitive sensor on each of said field controllers can be one, one set of combined many or comprise many used for standby.

7. The centralized photosensitive LED streetlight control system according to claim 3, wherein said photosensitive sensor on each of said field controllers can be one, one set of combined many or comprise many used for standby.

8. The centralized photosensitive LED streetlight control system according to claim 4, wherein said photosensitive sensor on each of said field controllers can be one, one set of combined many or comprise many used for standby.

9. The centralized photosensitive LED streetlight control system according to claim 1, wherein said field controller realizes a function of controlling both clock and photosensitive sensor through software.

10. The centralized photosensitive LED streetlight control system according to claim 2, wherein said field controller realizes a function of controlling both clock and photosensitive sensor through software.

11. The centralized photosensitive LED streetlight control system according to claim 3, wherein said field controller realizes a function of controlling both clock and photosensitive sensor through software.

12. The centralized photosensitive LED streetlight control system according to claim 4, wherein said field controller realizes a function of controlling both clock and photosensitive sensor through software.

13. The centralized photosensitive LED streetlight control system according to claim 5, wherein said field controller realizes a function of controlling both clock and photosensitive sensor through software.

14. The centralized photosensitive LED streetlight control system according to claim 6, wherein said field controller realizes a function of controlling both clock and photosensitive sensor through software.

15. The centralized photosensitive LED streetlight control system according to claim 7, wherein said field controller realizes a function of controlling both clock and photosensitive sensor through software.

16. The centralized photosensitive LED streetlight control system according to claim 8, wherein said field controller realizes a function of controlling both clock and photosensitive sensor through software.

17. The centralized photosensitive LED streetlight control system according to claim 1, wherein said field controller realizes a memory control function through software; namely, when all photosensitive sensors fail, said field controller is able to effect control according to the on and off times of streetlight on the last day.

18. The centralized photosensitive LED streetlight control system according to claim 2, wherein said field controller realizes a memory control function through software; namely, when all photosensitive sensors fail, said field controller is able to effect control according to the on and off times of streetlight on the last day.

19. The centralized photosensitive LED streetlight control system according to claim 3, wherein said field controller realizes a memory control function through software; namely, when all photosensitive sensors fail, said field controller is able to effect control according to the on and off times of streetlight on the last day.

20. The centralized photosensitive LED streetlight control system according to claim 16, wherein said field controller realizes a memory control function through software; namely, when all photosensitive sensors fail, said field controller is able to effect control according to the on and off times of streetlight on the last day.
